(19) United States
(12) Patent Application Publication
(10) Pub. No.: US 2017/0062777 A1
(43) Pub. Date: Mar. 2, 2017

(54) LEAD ACID SAFETY BATTERY CAP SYSTEM

(71) Applicant: EDWARD SCHWARZ, Santa Fe Springs, CA (US)

(72) Inventor: EDWARD SCHWARZ, Santa Fe Springs, CA (US)

(21) Appl. No.: 14/834,116

(22) Filed: Aug. 24, 2015

(51) Int. Cl. H01M 2/04; H01M 10/12

(52) U.S. Cl. CPC H01M 2/043; H01M 10/12; H01M 2200/00; H01M 2220/20

(57) ABSTRACT

A battery cap system for use in an electric storage battery is provided. The storage battery has a battery case and a cover positionable thereon. The cover is formed with through openings through which terminal posts extend for connecting the battery in an appropriate electrical circuit. The battery cover is formed with one or more cell access openings. The batterycap system comprises an elongated closure housing having a top side, a bottom side, a first end, and a second end. An outer wall forms an outside perimeter of the closure housing. A first stopper receiving aperture is formed in the first end of the closure housing, a second stopper receiving aperture is formed in the second end of the closure housing, and a third stopper receiving aperture is formed between the first end of the closure housing and the second end of the closure housing. The closure housing is semi-flexible to accommodate different sizes of batteries.

### BACKGROUND OF THE INVENTION

1. Field of the Invention

This invention relates generally to a lead-acid safety battery cap system and, more particularly, the invention relates to battery caps for insertion into fill ports of a lead-acid storage battery system, particularly deep cycle, high charge and high discharge batteries of the type utilized on golf carts and other battery powered vehicles.

2. Description of the Prior Art

A typical lead-acid battery consists of a plurality of cells filled with aqueous sulfuric acid electrolyte. The cells employ negative plates using lead as the electroactive material and positive plates in which lead oxide is the electroactive material. Sets of an equal number of positive and negative plates in the electrolyte are referred to as cells. Each lead-acid cell produces two volts per cell. The assembly of several cells in a series circuit to produce a higher voltage is called a battery.

Each cell in a battery has a fill opening which requires a battery cap. The purpose of the fill opening is to provide an opening for electrolyte filling and water replacement. The fill opening also provides a path to vent gas that is produced during charging and discharging of the battery.

The purpose of the battery cap is to prevent the electrolyte from spilling or spewing from the battery cells. The sulfuric acid battery electrolyte is highly caustic and can cause injury to persons upon contact, eat holes in clothing and other fabric materials, and rapidly corrode metal if it is ejected from the battery. Therefore, it is highly desirable to prevent electrolyte from escaping the battery case. During charging a battery generates bubbles within the acid that can and do spew electrolyte from the battery unless precautions are taken. Conventional prior art battery caps are therefore equipped with splash guards, baffles and other devices designed to recover and return to the battery cells electrolyte spewed from the battery.

Lead-acid cell batteries have intrinsic hazards. It is well known that lead-acid storage batteries utilized on motor vehicles emit potentially explosive gases during charging and discharging. During the normal course of charging and discharging a battery, a potentially explosive mixture of oxygen and hydrogen is liberated. A conventional battery cap is not a solid structure, but is typically hollow and includes one or more passageways to vent the mixture of oxygen and hydrogen from the battery compartment to the atmosphere at a slow rate. This process is referred to as off-gassing.

An inherent danger that accompanies the off gassing process is the possibility that a spark, flash or flame might enter the battery cell through the vent passageway of a battery caw If this occurs the volatile, explosive gases are ignited within the battery, whereupon the battery will explode. If this happens acid and battery fragments are thrown through the air. When this occurs damage to the battery compartment is very likely, and the risk of personal injury is quite great.

Because of the risk of personal injury and property damage that may occur, original equipment manufacturers (OEM's) and battery distributors have insisted in recent years that battery caps utilized on batteries with which they deal must be APF (flame retardant approved). This is achieved by utilizing a microporous disc as a flame barrier in each battery cap. This microporous disc acts as a spark or flame arrester.

One problem created by porous disc spark arresters is the “loading” or destruction of the porosity of the microporous filter from suspended particulate contamination carried by the gas bubbles during off gassing. Such contaminants do not pass through the microporous filter but are instead loaded into the open pores of the porous disc. As a result of this process the porosity of the filter disc is reduced from its design specifications. As this occurs internal battery gas pressure rises. As pressure increases above and beyond atmospheric pressure, battery acid is spewed through a conventional battery cap and into a battery compartment. This results in a loss of electrolyte which, when it escapes the battery, is likely to cause injury or damage.

Also, the buildup of gas pressure within a battery alters the “battery envelope”. That is, gas pressure buildup within a battery alters the outside dimensions of the battery. The battery bulges and can damage the battery compartment. Also, unless pressure is relieved the battery can crack and leak electrolyte.

In the past battery caps have been designed to attempt to solve these problems. In some cases the porous disc is protected by splash guards. Examples of battery caps constructed in this way are described, for example, in U.S. Pat. Nos. 5,422,199; 5,209,992; 4,400,450; and 5,132,175. Also, some battery caps have been designed with labyrinth paths. Examples of these types of battery caps are found in U.S. Pat. Nos. 5,132,175; 5,209,992; and 5,422,199. In other battery caps special types of chambers have been constructed. Examples of these appear in U.S. Pat. Nos. 4,400,450; 5,132,175 and 5,422,199.

Some conventional battery caps perform satisfactorily when utilized on relatively shallow cycle batteries of the type employed for ignition in a gasoline or diesel fuel powered vehicle. However, until the present invention battery caps employing microporous disc spark or flame arresters have not been feasible for use with the high charge and high discharge batteries required as the sole power source for vehicles such as golf carts, warehouse forklifts and other such vehicles. Some of the deep cycle batteries suitable for such vehicles are sold with the trade designations 250's, L16's, J185's, and Scrubbers.

The introduction of the widespread requirement for spark and flame arresters has created a new set of problems in lead-acid electrical storage batteries. One of these problems is the interruption of the natural equilibrium of the internal gas pressure within a battery cell and the outside atmosphere. This imbalance in equilibrium is made progressively worse by the deterioration of the porous disc spark or flame arrester. This deterioration results from the agglomeration of particulate contaminants in the porous disc that are carried in the aqueous electrolyte solution.

During the usual charging and discharging cycle of a battery the negative lead plates and positive lead oxide plates of the battery gradually erode. Particles from the heavy-metal plates are carried into the aqueous sulfuric acid electrolyte as dissolved, particulate matter. These particles eventually precipitate to the bottom of the battery. This byproduct is called “mud” in the battery industry.

During agitation and jostling of the battery that occurs as a battery powered vehicle travels, the particles of “mud” are carried into suspension in the electrolyte. These particles are ultimately transported to the microporous flame arrester by gas bubbles created in the electrolyte during charging and discharging and by spewing electrolyte.

### SUMMARY

The present invention is a lead-acid safety battery cap system for use in an electric storage battery is provided. The storage battery having a battery case and a cover positionable on the battery case. The cover is formed with through openings through which terminal posts extend for connecting the battery in an appropriate electrical circuit. The battery cover is formed with one or more cell access openings. The battery cap system comprises an elongated closure housing having a top side, a bottom side, a first end and a second end. An outer wall forms an outside perimeter of the closure housing. A first stopper receiving aperture is formed in the first end of the closure housing, a second stopper receiving aperture is formed in the second end of the closure housing, and a third stopper receiving aperture is formed approximately halfway between the first end of the closure housing and the second end of the closure housing. The closure housing is semi-flexible to accommodate different sizes of batteries.

In addition, the present invention includes a lead-acid safety battery cap system for use in an electric storage battery. The electric storage battery has a battery case and a cover positionable on the battery case. The cover is formed with through openings through which terminal posts extend for connecting the battery in an appropriate electrical circuit. The battery cover is formed with one or more cell access openings. The battery cap system comprises an elongated, flexible closure housing having a top side, a bottom side opposite-the top side, a first end and a second end opposite the first end. A first stopper receiving aperture is formed in the first end of the closure housing, a second stopper receiving aperture is formed in the second end of the closure housing, and a third stopper receiving aperture is formed approximately halfway between the first end of the closure housing and the second end of the closure housing. A first tubular stopper device is releasably securable within the first stopper receiving aperture, a second tubular stopper device releasably securable within the second stopper receiving aperture, and a third tubular stopper device releasably securable within the third stopper receiving aperture. The closure housing is semi-flexible to accommodate different sizes of batteries.

### BRIEF DESCRIPTION OF THE DRAWINGS

FIG. 1 is an elevational side view illustrating a battery cap system, constructed in accordance with the present invention, with a plurality of stopper devices releasably secured thereto;

FIG. 2 is a bottom plan view illustrating the battery cap system of FIG. 1, constructed in accordance with the present invention;

FIG. 3 is a top plan view illustrating the battery cap system, constructed in accordance with the present invention, with one stopper device releasably secured thereto;

FIG. 4 is a bottom plan view illustrating the battery cap system of FIG. 3, constructed in accordance with the present invention;

FIG. 5 is an elevational side view illustrating the stopper device of the battery cap system, constructed in accordance with the present invention;

FIG. 6 is a perspective view of the stopper device of the battery cap system, constructed in accordance with the present invention, with a microporous filter disc, a diverter, and a cap;

FIG. 7 is a top plan view of the stopper device of the battery cap system, constructed in accordance with the present invention, with a microporous filter disc, a diverter, and a cap; and

FIG. 8 is a bottom plan view of the stopper device of the battery cap system, constructed in accordance with the present invention, with a microporous filter disc, a diverter, and a cap.

### DETAILED DESCRIPTION OF THE PREFERRED EMBODIMENTS

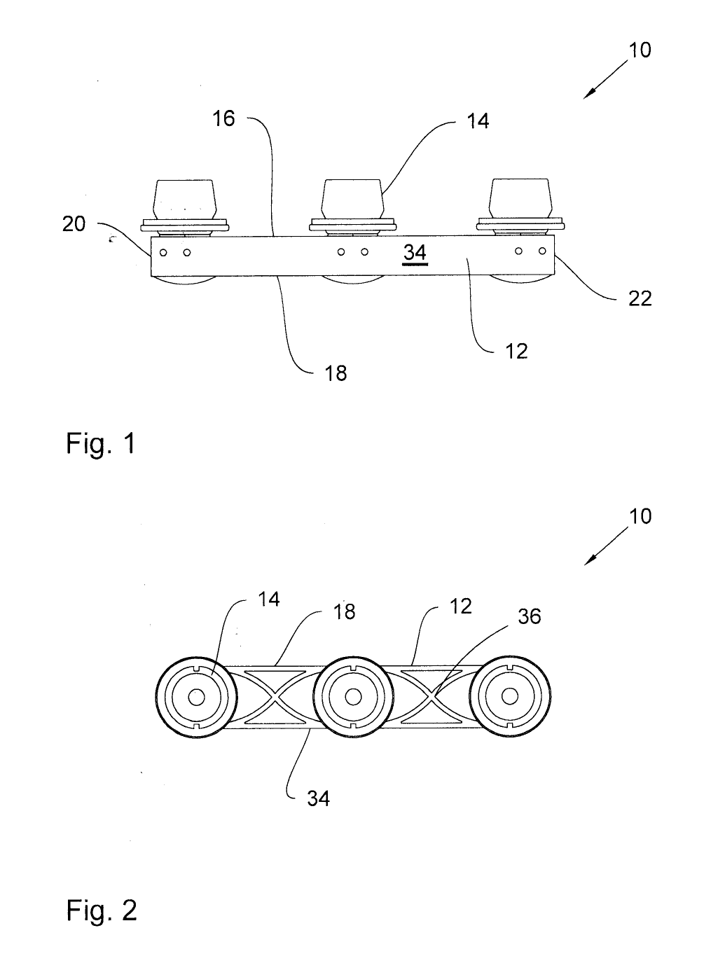

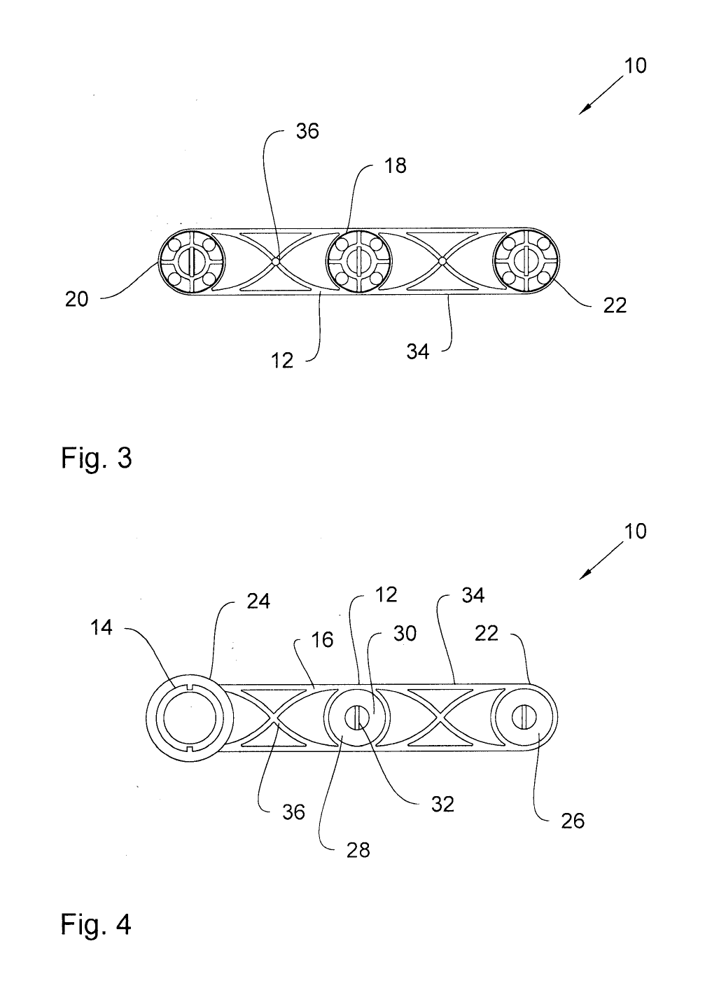

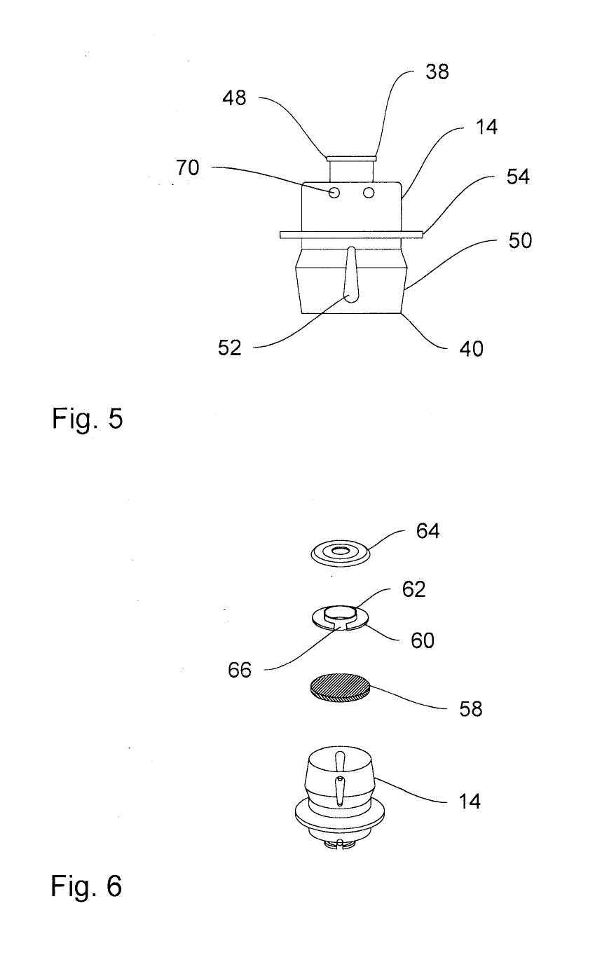

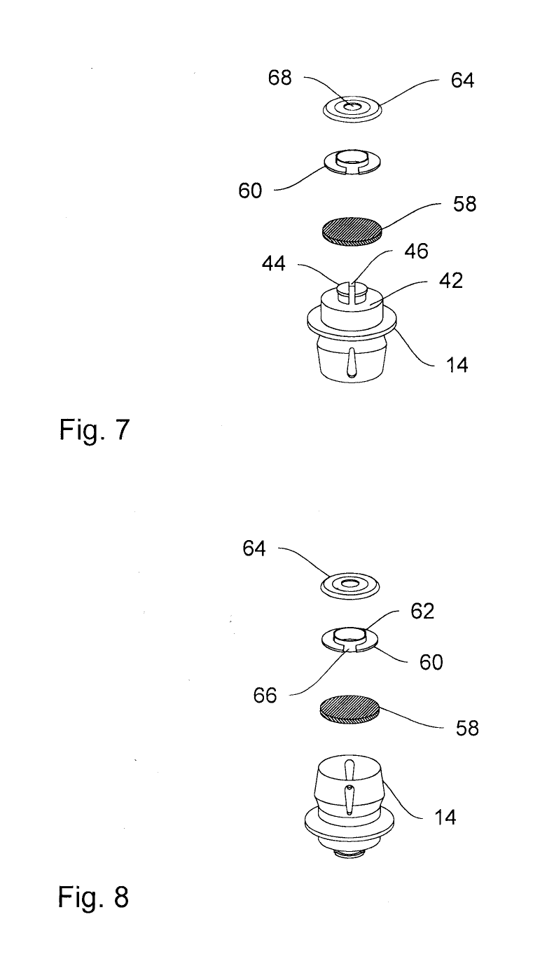

As illustrated in FIGS. 1-8, the present invention is a lead-acid safety battery cap system, indicated generally at 10, with a closure housing 12 having ganged stopper devices 14 whereby all of the stopper devices 14 can be inserted into the various cell access openings or removed therefrom, as desired, in a single, non-rotating, normally vertical motion.

The battery cap system 10 of the present invention is used in an electric storage battery having a battery case and a cover therefor. The cover is formed with appropriate through openings through which terminal posts extend for connecting the battery in an appropriate electrical circuit. Mounted on the cover of battery is the closure housing according to the present invention.

The battery cover of the battery cap system 10 is formed with one or more cell access openings through which access is afforded to the cells of the battery. Such access is opening is usually circular in shape and is adapted to receive a plug or the like for properly sealing the respective cell.

The closure housing 12 of the battery cap system 10 of the present invention is an elongated housing having a top side 16, a bottom side 18 opposite the top side 16, a first end 20, and a second end 22 opposite the first end 20. A first stopper receiving aperture 24 is formed in the first end 20 of the closure housing 12, a second stopper receiving aperture 26 is formed in the second end 22 of the closure housing 12, and a third stopper receiving aperture 28 is formed approximately halfway between the first end 20 of the closure housing 12 and the second end 22 of the closure housing 12. Each stopper aperture has a base wall 30 with an opening formed in the base wall 30. A cross bar 32 extends completely across the opening to assist in releasably securing the stopper device 14 within the respective stopper receiving aperture, as will be described in further detail below.

An outer wall 34 is formed along an outside perimeter of the closure housing 12 of the battery cap system 10 of the present invention. A plurality of ribs 26 are formed entirely within the outer wall 34 between the first stopper receiving aperture 24 and the third stopper receiving aperture 28 and between the second stopper 26 receiving aperture and the third stopper receiving aperture 28. Preferably, there are two crisscrossing ribs 25 between each adjacent pair of stopper receiving apertures.

In a preferred embodiment, the closure housing 12 of the battery cap system 10 of the present invention is constructed from a semi-flexible, molded plastic material. With the use of the preferred material together with the construction and placement of the ribs 36, the closure housing 12 is semi-flexible to accommodate different sizes of batteries, as desired.

In addition, the battery cap system 10 of the present invention includes a plurality of tubular stopper devices 14 with a single stopper device 14 releasably securable within the first stopper receiving aperture 24, the second stopper receiving aperture 26, and the third stopper receiving aperture 28. Each stopper device 14 has a first end 38 and a second end 40. The first end 38 of each stopper device 14 includes a wall 42 with an attachment extension 44 extending from the wall 42. The attachment extension 44 has an annular shoulder 48 and a slot 46. To releasably secure the stopper device 14 in the respective stopper receiving aperture, the stopper device 14 is inserted into the bottom side 18 of the closure housing 12 into the respective stopper receiving aperture with the slot 46 receiving the cross bar 32 formed in each stopper receiving aperture until the shoulder 48 passes through and past the base wall 30 of each stopper receiving aperture. The shoulders 48 inhibit the stopper device 14 from becoming inadvertently dislodged from the respective stopper receiving aperture.

The second end 40 of each stopper device 14 of the battery cap system 10 of the present invention includes a deformable plug 50 insertable into the cell access opening of the battery. The second end 40 of each stopper device 14 is preferably tapered outward from the second end 40 toward the first end 38 to a predetermined point and then tapers inward until an approximate center of the stopper device 14. Formed in the second end 40 of the stopper device 14 are a pair of slots 52 allowing the second end 40 of the stopper device 14 to deform while being inserted into the cell access opening and then resume its normal configuration once completely inserted. An annular extension member 54 is positioned about the approximate center of each stopper device 14 to limit the extent of insertion of each stopper member 14 into the respective cell access opening. A gasket 56 can be provided to provide a better seal between the stopper device 14 and the closure housing 12.

The battery cap system 10 of the present invention additionally includes a microporous flame arrester disc 58 positioned into the second end 40 of the stopper device 14 resting against the wall 42. The circular, peripheral edge of the microporous filter disc 58 resides in contact with the interior surface of the interior wall of the tubular stopper device 14 throughout its circumference so that the filter disc 58 forms a spark arrester or flame arrester. The filter disc 58 thereby provides a barrier to ignition of explosive gases beneath it structure.

Furthermore, the battery cap system 10 of the present invention has a circular diverter 60 having a first side and a second side. A pair of approximately semi-circular extension legs 62 extend from both the first side and the second side of the diverter 60 with an opening between each pair of extension legs 62. The extension legs 62 on the first side of the diverter spaces the diverter from the porous disc 58 and the extension legs 62 on the second side of the diverter 60 spaces the diverter from a sealing cap 64, as will be described below. A pair of diametrically opposed notches 66 are formed in the diverter 60 at its peripheral edge adjacent the extension legs 62.

The battery cap system 10 further includes the sealing cap 64 positionable upon the extension legs 62 of the diverter 60. The sealing cap 64 has an aperture 68 therethrough allowing gas to pass through the aperture 68 during use. Once the gas passes through the aperture 68 of the sealing cap 64, the gas travels through the cutout portions 66 and into the microporous flame arrester disc 58. A circuitous pathway is thereby defined that allows gas to escape through the porous disc 58 and out from the stopper device 14 through the pair of laterally spaced gas escape ports 70 that are defined through the wall of the stopper device 14. A top cap 72 is mounted to the first side of the closure housing 12 covers the first side of the stopper mechanism 14 and inhibits gas from escaping.

The battery cap system 10 of the present invention provides a closure housing 12 constructed from a semi-flexible, molded plastic material and ribs allowing the closure housing 12 is semi-flexible to accommodate different sizes of batteries, as desired. While at the same time, the battery cap system 10 sufficiently vents gas produced in the battery to the outside atmosphere, as described in U.S. Pat. No. 6,746,795, which is herein hereby incorporated by reference.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

What is claimed is:

1. A lead-acid safety battery cap system for use in an electric storage battery, the electric storage battery having a battery case and a cover positionable on the battery case, the cover being formed with through openings through which terminal posts extend for connecting the battery in an appropriate electrical circuit, the battery cover formed with one or more cell access openings, the battery cap system comprising:
an elongated closure housing having a top side, a bottom side opposite the top side, a first end and a second end opposite the first end;
an outer wall forms an outside perimeter of the closure housing;
a first stopper receiving aperture is formed in the first end of the closure housing;
a second stopper receiving aperture is formed in the second end of the closure housing; and
a third stopper receiving aperture is formed approximately halfway between the first end of the closure housing and the second end of the closure housing;
wherein the closure housing is semi-flexible to accommodate different sizes of batteries.

2. The battery cap system of claim 1 and further comprising:
a first plurality of ribs formed entirely within the outer wall between the first stopper receiving aperture and the third stopper receiving aperture; and
a second plurality of ribs formed between the second stopper receiving aperture and the third stopper receiving aperture.

3. The battery cap system of claim 2 wherein the first plurality of ribs crisscross between the first stopper receiving aperture and the third stopper receiving aperture and the second plurality of ribs crisscross between the second stopper receiving aperture and the third stopper receiving aperture.

4. The battery cap system of claim 1 and further comprising:
a stopper device having a first end and a second end;
wherein the stopper device is releasably securable within one of the topper receiving apertures.

5. The battery cap system of claim 4 and further comprising:
a first tubular stopper device releasably securable within the first stopper receiving aperture;
a second tubular stopper device releasably securable within the second stopper receiving aperture;
a third tubular stopper device releasably securable within the third stopper receiving aperture.

6. The battery cap system of claim 4 wherein each stopper aperture has a base wall with an opening formed in the base wall and a cross bar extending completely across each opening, and wherein the first end of the stopper device has a wall with an attachment extension extending from the wall, the attachment extension having an annular shoulder and a slot, the slot receiving the cross bar, until the shoulder passes through and past the base wall of each stopper receiving aperture.

7. The battery cap system of claim 4 wherein the second end of the stopper device includes a deformable plug insertable into the cell access opening of the battery.

8. The battery cap system of claim 7 wherein the second end of the stopper device is tapered outward from the second end toward the first end to a predetermined point and then tapers inward until an approximate center of the stopper device.

9. The battery cap system of claim 8 wherein the second end has a pair of slots allowing the second end of the stopper device to deform while being inserted into the cell access opening and then resume its normal configuration once completely inserted.

10. The battery cap system of claim 4 and further comprising:
an annular extension member positioned about the approximate center of the stopper device to limit the extent of insertion of the stopper member into the respective cell access opening.

11. The battery cap system of claim 10 and further comprising:
a gasket positioned about the second end of the stopper device and resting against the annular extension member.

12. The battery cap system of claim 4 and further comprising:
a microporous flame arrester disc positioned into the second end of the stopper device, the disc residing in contact with the interior surface of the interior wall of the tubular stopper device throughout its circumference.

13. The battery cap system of claim 12 and further comprising:
a circular diverter having a first side and a second side;
a pair of approximately semi-circular extension legs extending from both the first side and the second side with an opening between each pair of extensions;
a pair of diametrically opposed notches are formed in the diverter at its peripheral edge adjacent the extensions;
wherein the extension legs on the first side of the diverter spaces the diverter from the porous disc and the extension legs on the second side of the diverter spaces the diverter from a cap.

14. The battery cap system of claim 13 and further comprising:
a sealing cap positionable upon the extensions of the diverter; and
an aperture formed through the sealing cap.

15. The battery cap system of claim 14 and further comprising:
a top cap mounted to the first side of the closure housing covering the first side of the stopper mechanism.

16. A lead-acid safety battery cap system for use in an electric storage battery, the electric storage battery having a battery case and a cover positionable on the battery case, the cover being formed with through openings through which terminal posts extend for connecting the battery in an appropriate electrical circuit, the battery cover formed with one or more cell access openings, the battery cap system comprising:
an elongated, flexible closure housing having a top side, a bottom side opposite the top side, a first end and a second end opposite the first end;
a first stopper receiving aperture is formed in the first end of the closure housing;
a second stopper receiving aperture is formed in the second end of the closure housing;
a third stopper receiving aperture is formed approximately halfway between the first end of the closure housing and the second end of the closure housing;
a first tubular stopper device releasably securable within the first stopper receiving aperture;
a second tubular stopper device releasably securable within the second stopper receiving aperture; and
a third tubular stopper device releasably securable within the third stopper receiving aperture;
wherein the closure housing is semi-flexible to accommodate different sizes of batteries.

17. The battery cap system of claim 16 and further comprising:
an outer wall forms an outside perimeter of the closure housing;
a first plurality of ribs formed entirely within the outer wall between the first stopper receiving aperture and the third stopper receiving aperture; and
a second plurality of ribs formed between the second stopper receiving aperture and the third stopper receiving aperture.

18. The battery cap system of claim 17 wherein the first plurality of ribs crisscross between the first stopper receiving aperture and the third stopper receiving aperture and the-second plurality of ribs crisscross between the second stopper receiving aperture and the third stopper receiving aperture.

19. The battery cap system of claim 16 wherein each stopper aperture has a base wall with an opening formed in the base wall and a cross bar extending completely across each opening, and wherein the first end of the stopper device has a wall with an attachment extension extending from the wall, the attachment extension having an annular shoulder and a slot, the slot receiving the cross bar, until the shoulder passes through and past the base wall of each stopper receiving aperture.

20. The battery cap system of claim 19 and further comprising:
a microporous flame arrester disc positioned into the second end of the stopper device, the disc residing in contact with the interior surface of the interior wall of the tubular stopper device throughout its circumference;
a circular diverter having a first side and a second side;
a pair of approximately semi-circular extension legs extending from both the first side and the second side with an opening between each pair of extensions;
a pair of diametrically opposed notches are formed in the diverter at its peripheral edge adjacent the extensions;
wherein the extension legs on the first side of the diverter spaces the diverter from the porous disc and the extension legs on the second side of the diverter spaces the diverter from a cap;
a sealing cap positionable upon the extensions of the diverter;
an aperture formed through the sealing cap; and
a top cap mounted to the first side of the closure housing covering the first side of the stopper mechanism.
